(19) United States
(12) Patent Application Publication
(10) Pub. No.: US 2018/0278755 A1
(43) Pub. Date: Sep. 27, 2018

(54) IMAGE MANAGEMENT SYSTEM, IMAGE MANAGEMENT SERVER, AND NON-TRANSITORY COMPUTER READABLE MEDIUM

(71) Applicant: FUJI XEROX CO., LTD., Tokyo (JP)

(72) Inventors: Eiji NISHI, Kanagawa (JP); Keita SAKAKURA, Kanagawa (JP); Ryuichi ISHIZUKA, Kanagawa (JP); Chigusa NAKATA, Kanagawa (JP); Hiroshi HONDA, Kanagawa (JP); Yoshihiro SEKINE, Kanagawa (JP); Kenji KUROISHI, Kanagawa (JP); Hiroshi MIKURIYA, Kanagawa (JP); Takeshi FURUYA, Kanagawa (JP)

(73) Assignee: FUJI XEROX CO., LTD., Tokyo (JP)

(21) Appl. No.: 15/893,783

(22) Filed: Feb. 12, 2018

(30) Foreign Application Priority Data
Mar. 24, 2017 (JP) 2017-058610

(51) Int. Cl. H04N 1/00; H04N 1/21; H04N 1/32; G06F 17/30

(52) U.S. Cl. CPC H04N 1/0023; H04N 1/00244; H04N 1/00228; H04N 1/42; H04N 1/00129; H04N 1/32128; G06F 17/30203; H04N 1/2166

(57) ABSTRACT

An image management system includes an image output apparatus and an image management server. The image output apparatus displays and outputs an image. The image management server manages the image output from the image output apparatus. The image output apparatus captures, as image files, an image that is based on a specific data file and an image that is not based on the specific data file, in accordance with a predetermined capture condition, and transmits the image files to the image management server. The image management server includes a management unit that holds the image files received from the image output apparatus, and manages the image that is not based on the specific data file in association with the specific data file, and a communication controller that transmits, when receiving a request for an image, the request specifying the specific data file, the image associated with the specific data file.

### CROSS-REFERENCE TO RELATED APPLICATIONS

This application is based on and claims priority under 35 USC 119 from Japanese Patent Application No. 2017-058610 filed Mar. 24, 2017.

### BACKGROUND

### Technical Field

The present invention relates to an image management system, an image management server, and a non-transitory computer readable medium.

### SUMMARY

According to an aspect of the invention, there is provided an image management system including an image output apparatus and an image management server. The image output apparatus displays and outputs an image. The image management server manages the image output from the image output apparatus. The image output apparatus captures, as image files, an image that is based on a specific data file and an image that is not based on the specific data file, in accordance with a predetermined capture condition, and transmits the image files to the image management server. The image management server includes a management unit that holds the image files received from the image output apparatus, and manages the image that is not based on the specific data file in association with the specific data file, and a communication controller that transmits, when receiving a request for an image, the request specifying the specific data file, the image associated with the specific data file.

### BRIEF DESCRIPTION OF THE DRAWINGS

Exemplary embodiments of the present invention will be described in detail based on the following figures, wherein:

FIG. 1 is a diagram illustrating the entire configuration of an image management system according to an exemplary embodiment of the present invention;

FIG. 2 is a diagram illustrating a functional configuration of an image output apparatus;

FIG. 3 is a diagram illustrating a functional configuration of an image management server;

FIG. 4 is a diagram illustrating an example of a configuration of a database of image files managed by a data management unit;

FIG. 5 is a flowchart illustrating an operation of an image output apparatus;

FIG. 6 is a flowchart illustrating an operation at a time when an image management server acquires an image;

FIG. 7 is a flowchart illustrating an operation when an image management server receives a request for an image file;

FIG. 8 is a diagram illustrating another example of the configuration of the image management system;

FIG. 9 is a diagram illustrating another example of the configuration of the image management system;

FIG. 10 is a diagram illustrating another example of the configuration of the image management system; and

FIG. 11 is a diagram illustrating another example of the configuration of the image management system.

### DETAILED DESCRIPTION

Exemplary embodiments of the present invention will be described in detail below with reference to attached drawings.

### <System According to Exemplary Embodiment>

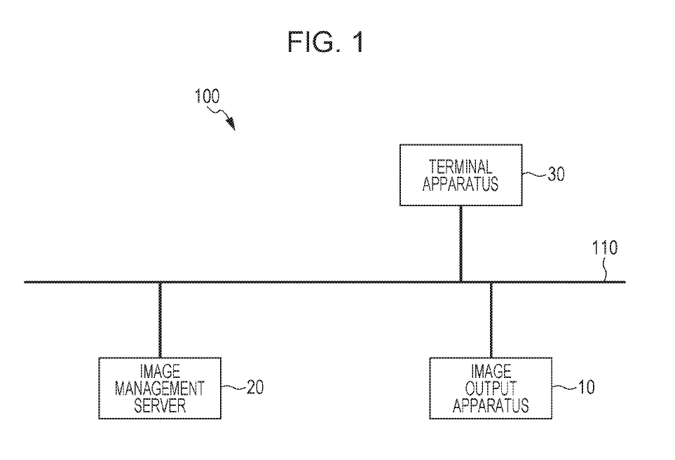

FIG. 1 is a diagram illustrating the entire configuration of an image management system 100 according to an exemplary embodiment of the present invention. As illustrated in FIG. 1, the image management system 100 according to this exemplary embodiment includes an image output apparatus 10 and an image management server 20. The image output apparatus 10 and the image management server 20 are connected to each other via a network 110. The network 110 is, for example, an in-house local area network (LAN) or the like, and a communication line used for data communication may be wired or wireless.

In the example illustrated in FIG. 1, a terminal apparatus 30 is connected to the image output apparatus 10. The image output apparatus 10 is an apparatus that displays and outputs electronic images. Specifically, for example, a projector, a liquid crystal display, or the like may be used as the image output apparatus 10. The terminal apparatus 30 is implemented by, for example, a personal computer or a mobile information terminal, and functions as a controller that controls the image output apparatus 10. The terminal apparatus 30 is also connected to the image management server 20 via the network 110.

At an event such as a conference, in the image management system 100 according to this exemplary embodiment, an image is displayed by the image output apparatus 10, the displayed image is captured as an image file, and the image file is stored in the image management server 20. The terminal apparatus 30 controls the image output apparatus 10 to display an image to be presented to a participant. In this exemplary embodiment, at an event, a specific document is distributed as a handout to participants, and the document is displayed as an image on the image output apparatus 10. The document may be, for example, distributed as a document printed on paper to participants. Alternatively, the document may be prepared as a data file (document file), and may be distributed by being transferred to information apparatuses (personal computers, mobile information terminals, etc.) of participants, using electronic mail or other ways of data transfer. For distribution by paper, a data file is also prepared and stored in the terminal apparatus 30 so as to be used for display by the image output apparatus 10. In FIG. 1, one image output apparatus 10 and one terminal apparatus 30 are illustrated. However, plural image output apparatuses 10 or plural terminal apparatuses 30 may be provided.

In the execution of an event, for example, during the progress of a conference, documents different from handouts prepared in advance may be displayed by the image output apparatus 10. In such a case, in this exemplary embodiment, an image file is created even for an image that is displayed by the image output apparatus 10 based on an unplanned document, in a similar manner to an image based on a specific document as a handout, and the image file is stored into the image management server 20.

The image management server 20 holds, for each event, image files acquired from the image output apparatus 10. Furthermore, the image management server 20 associates an image file based on a document different from a handout with a document as a handout of a corresponding event, and manages the image file based on the document different from the handout, along with the image file based on the handout. Moreover, in the case where the image management server 20 according to this exemplary embodiment receives a request for an image, the request specifying an event and a document as a handout for the event, from an external apparatus (not illustrated in FIG. 1), the image management server 20 transmits an image associated with the document (an image of a different document displayed at the event), along with the image of the document as the handout, to the external apparatus.

### <Functional Configuration of Image Output Apparatus>

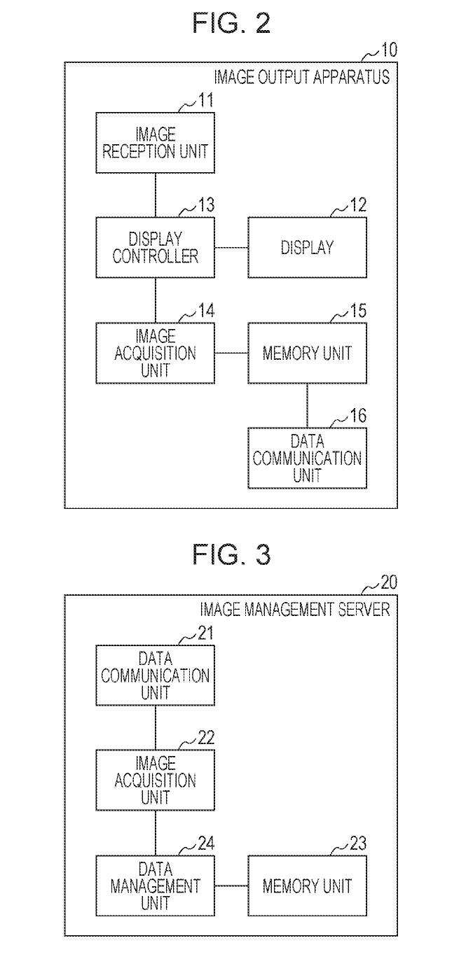

FIG. 2 is a diagram illustrating a functional configuration of the image output apparatus 10. As illustrated in FIG. 2, the image output apparatus 10 includes an image reception unit 11, a display 12, a display controller 13, an image acquisition unit 14, a memory unit 15, and a data communication unit 16.

The image reception unit 11 is an interface for receiving image data. For example, a high-definition multimedia interface (HDMI®) or digital visual interface (DVI) is used as the image reception unit 11. The image output apparatus 10 and the terminal apparatus 30 are connected to each other via the image reception unit 11.

The display 12 displays images acquired via the image reception unit 11. A display method is not particularly limited. For example, the display 12 may be used as a projector which projects images on a screen or a display which includes a display screen such as a liquid crystal display.

The display controller 13 is a driver that controls display of images by the display 12. A function of the display controller 13 is implemented by, for example, executing, with a processor, a program stored in a memory. The display controller 13 according to this exemplary embodiment acquires image data from the terminal apparatus 30 via the image reception unit 11, and causes the display 12 to display the image data.

The image acquisition unit 14 captures an image displayed by the display 12 as an image file when a predetermined capture condition is satisfied. A function of the image acquisition unit 14 is implemented by, for example, executing, with a processor, a program stored in a memory. The capture condition may be, for example, that an image (output image) displayed on the display 12 is changed. That is, an image file is created every time that an output image changes. Furthermore, the capture condition may be that a predetermined time (for example, five seconds) has passed since an output image changed. Accordingly, as in the case where plural images are continuously switched while an operator of the terminal apparatus 30 is searching for an image to be displayed, an image displayed without the purpose of being presented to participants of an event is excluded from image files stored in the image management server 20. A determination as to whether or not an output image is changed may be made, for example, based on a control signal acquired from the terminal apparatus 30. Furthermore, the determination as to whether or not an output image is changed may be made by obtaining a difference between images before and after a point in time when a control signal is acquired from the terminal apparatus 30 or a point in time specified with predetermined time intervals.

Furthermore, in the case where a displayed image is enlarged or reduced, it may be determined that an image is changed between before and after display magnification is changed. In this case, image files may be created such that images at different magnifications are defined as different images, or an image file may not be created by determining that images at different magnifications are the same image. In the latter case, it is necessary to determine that images before and after display magnification is changed are the same image. This determination may be made, for example, based on a control signal acquired from the terminal apparatus 30. Furthermore, a determination as to whether or not images before and after display magnification is changed are the same image may be made by analyzing the images before and after the display magnification is changed and examining whether or not one image is included in the other image.

Furthermore, when creating an image file, the image acquisition unit 14 may acquire information of an event and identification information of a document file that is opened on the terminal apparatus 30 and add the acquired information as attribute information of an image to the created image file. Information of an event may include identification information of the event, information of the location of the event, information of the time at which the event takes place, information of participants, and the like. Furthermore, when creating an image file, the image acquisition unit 14 may acquire specifications information such as prohibition of printing or the like from the terminal apparatus 30 and add the specifications information as attribute information of an image to the created image file.

The memory unit 15 is a memory that temporarily stores an image file created by the image acquisition unit 14. The memory unit 15 is implemented by, for example, a memory such as a random access memory (RAM). The data communication unit 16 is a network interface that allows connection with the image management server 20 via the network 110. An image file held in the memory unit 15 is transmitted to the image management server 20 via the network 110 from the data communication unit 16.

### <Functional Configuration of Image Management Server>

FIG. 3 is a diagram illustrating a functional configuration of the image management server 20. As illustrated in FIG. 3, the image management server 20 includes a data communication unit 21, an image acquisition unit 22, a memory unit 23, and a data management unit 24.

The data communication unit 21 is a network interface that allows connection with the image output apparatus 10 or the terminal apparatus 30 via the network 110. The image management server 20 receives, with the data communication unit 21, an image file transmitted from the image output apparatus 10 via the network 110. The image management server 20 also receives a request from the terminal apparatus 30, and sends a response to the terminal apparatus 30.

The image acquisition unit 22 receives an image file received by the data communication unit 21, and the image file is stored into the memory unit 23. A function of the image acquisition unit 22 is implemented by, for example, executing, with a processor, a program stored in a memory. The memory unit 23 is a memory that stores an image file received by the image acquisition unit 22. The memory unit 23 is implemented by, for example, a memory such as a RAM or a magnetic disk device.

The data management unit 24 manages an image file stored in the memory unit 23. The data management unit 24 manages an image file acquired from the image output apparatus 10, for each event in which the image output apparatus 10 is used. In this exemplary embodiment, an event in which an image file by the image output apparatus 10 is acquired is registered in advance in the data management unit 24. A determination as to at which event an image file transmitted from the image output apparatus 10 is output is made by, for example, acquiring identification information of the image output apparatus 10 from which the image file is transmitted, information of the location and time at which the image output apparatus 10 is used, and information of users or the like, along with the image file, and comparing the acquired information with information of the event registered in advance. Furthermore, regarding acquired image files, the data management unit 24 manages an image based on a document as a handout at an event and an image based on a document different from the handout (an image that is not based on the document as the handout) in a distinguished manner. An image based on a document different from a handout is managed in association with a document as the handout.

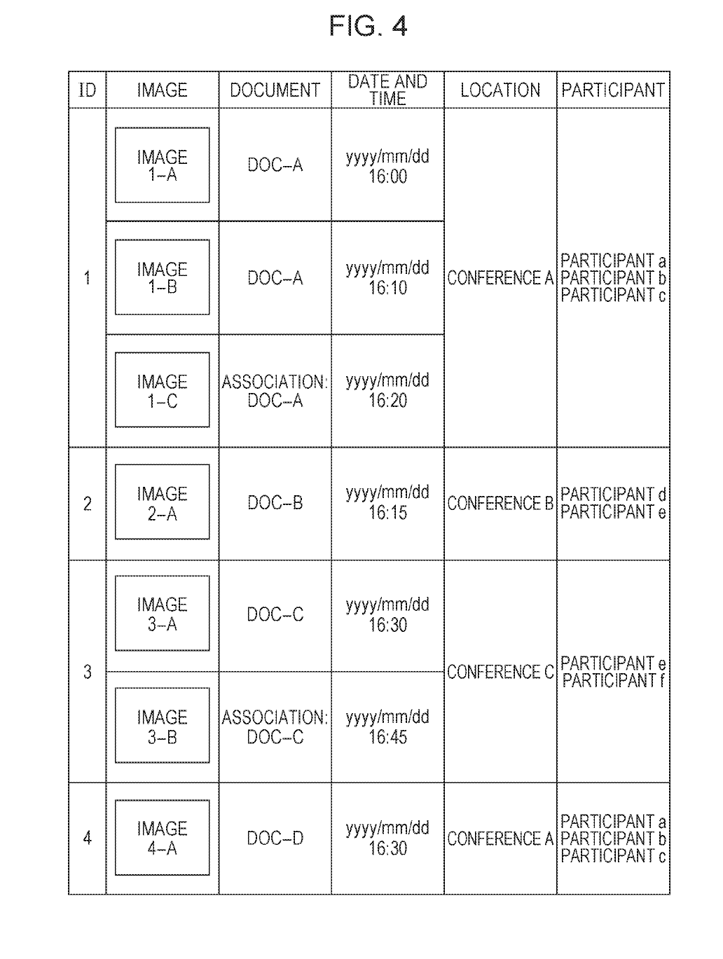

FIG. 4 is a diagram illustrating an example of a configuration of a database of image files managed by the data management unit 24. In the database illustrated in FIG. 4, an image file and information of an image and an event are stored, based on identification information (ID) for identifying an event. Specifically, identification information of a document of which an image is captured (or an associated document), the date and time at which an image file was acquired, the location where an event took place, and participants of the event are recorded. For example, the image management server 20 may acquire identification information of an event from the terminal apparatus 30, and acquire, based on the acquired identification information, information of the event (in the example illustrated in FIG. 4, date and time, location, and participants) from a schedule management server (not illustrated in figures) that manages an event schedule. Furthermore, the image output apparatus 10 may transmit identification information of an event, as attribute information of an image file created by the image output apparatus 10, along with the image file, to the image management server 20.

In the example illustrated in FIG. 4, for an event of ID1, three image files 1-A, 1-B, and 1-C are stored. Among them, the image files 1-A and 1-B represent images based on a document DOC-A as a handout. The image file 1-C represents an image based on a document different from the handout, and the image is associated with the document DOC-A. Similarly, for an event of ID2, an image file 2-A is stored, and the image file 2-A represents an image based on a document DOC-B as a handout. For an event of ID3, two image files 3-A and 3-B are stored. Among them, the image file 3-A represents an image based on a document DOC-C as a handout. The image file 3-B represents an image based on a document different from the handout, and the image is associated with the document DOC-C. For an event of ID4, an image file 4-A is stored, and the image file 4-A represents an image based on a document DOC-D as a handout.

Furthermore, in response to a request from an external apparatus, the data management unit 24 transmits an image file stored in the memory unit 23 to the external apparatus as a request source. An external apparatus may be, for example, a personal computer, a mobile information terminal, an image forming apparatus, or the like. The external apparatus is connected to the image management server 20 via the network 110, and transmits a request for an image file. A request for an image file is made, for example, by specifying a document as a handout of an event. For example, in the example illustrated in FIG. 4, the document DOC-A is specified, and a request for an image file is made. The data management unit 24 searches for an image file of the specified document, and checks whether or not an image file associated with the document exists. In the case where an image file associated with the specified document exists, the data management unit 24 reads the image file of the document and the associated image file, and transmits the image files to the external apparatus from which the request is transmitted. In the example of the request for the document DOC-A, the image files 1-A and 1-B based on the document DOC-A and the image file 1-C associated with the document DOC-A are stored in the database illustrated in FIG. 4, and therefore, the image files 1-A, 1-B, and 1-C are transmitted.

In the example illustrated in FIG. 4, one document is provided as a handout for an event. However, plural documents may be provided as handouts for an event. In this case, an image file that is not based on the documents as handouts may be associated with any document out of the plural documents as handouts or may be associated with only a predetermined specific document. The image file may be associated with all the documents as handouts.

### <Operation of Image Output Apparatus>

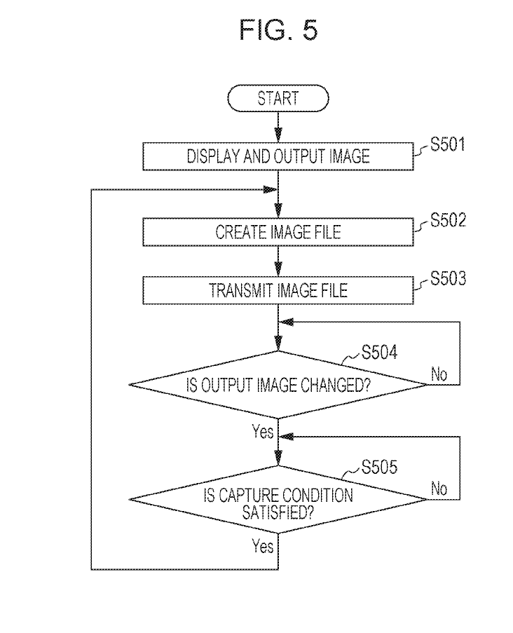

FIG. 5 is s flowchart illustrating an operation of the image output apparatus 10. In this operation example, a capture condition is that a predetermined time has passed since an output image was changed. As illustrated in FIG. 5, the image output apparatus 10 displays and outputs an image received from the terminal apparatus 30 via the image reception unit 11 (S501). Accordingly, a state before the first image is output is changed and the capture condition is satisfied. Therefore, the image acquisition unit 14 captures the displayed image and creates an image file (S502). Then, the data communication unit 16 transmits the created image file to the image management server 20 (S503).

When a new image is received from the terminal apparatus 30 and an output image is changed (S504), and when the predetermined time has passed and the capture condition is satisfied (S505), the image acquisition unit 14 of the image output apparatus 10 captures the displayed image and creates an image file again (S502). After that, every time that the image capture condition is satisfied, the image acquisition unit 14 creates an image file, and the created image file is transmitted to the image management server 20 via the data communication unit 16.

### <Operation of Image Management Server>

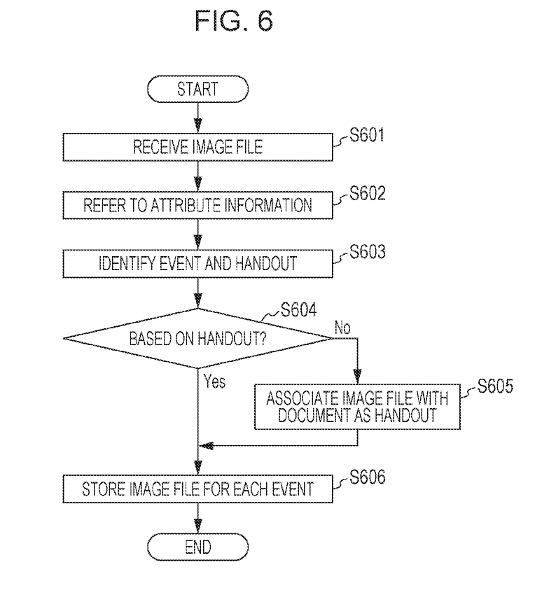

FIG. 6 is a flowchart illustrating an operation at a time when the image management server 20 acquires an image. In this operation example, identification information of an event and a document as a handout is added as attribute information to an image file transmitted from the image output apparatus 10. As illustrated in FIG. 6, when the image management server 20 receives an image file from the image output apparatus 10 (S601), the data management unit 24 refers to attribute information of the image file (S602), and identifies an event for which the image file is acquired and a document as a handout (S603). Then, in the case where the image is not based on the document as the handout for the event, the data management unit 24 associates the image file with the document as the handout (S604 and S605), and stores the image in the memory unit 23 for each event (S606).

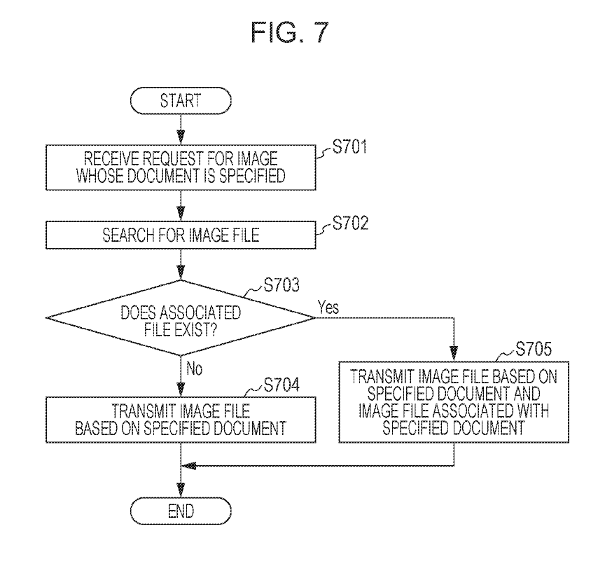

FIG. 7 is a flowchart illustrating an operation when the image management server 20 receives a request for an image file. As illustrated in FIG. 7, when the image management server 20 receives a request for an image, the request specifying an event and a document as a handout for the event, from an external apparatus (S701), the data management unit 24 searches for an image file for the specified event (S702). Then, in the case where there is no image file associated with the document specified in the request for the event, the data management unit 24 reads an image file based on the specified document, and transmits the read image file to the external apparatus as a request source (S703 and S704). In contrast, in the case where there is an image file associated with the specified document, the data management unit 24 reads, along with the image file based on the specified document, the image file associated with the specified document, and transmits the read image files to the external apparatus as the request source (S703 and S705).

### <Other Examples of System Configuration>

FIG. 8 is a diagram illustrating another example of a configuration of the image management system 100 according to an exemplary embodiment. In the system configuration illustrated in FIG. 1, the terminal apparatus 30 holds a document as a handout for an event. In contrast, in the system configuration illustrated in FIG. 8, a document management server (file management server) 40 that is connected to the network 110 is provided, and a document as a handout is registered and held in the document management server 40. With this configuration, in the case where the image management server 20 receives a request for an image, the request specifying a document, the image management server 20 may instruct the document management server 40 to transmit a document file of the specified document to an external apparatus from which the request is transmitted, instead of transmitting an image based on the specified document. In the case where there is an image file associated with the specified document, only the associated image file is transmitted to the external apparatus as a request source from the image management server 20.

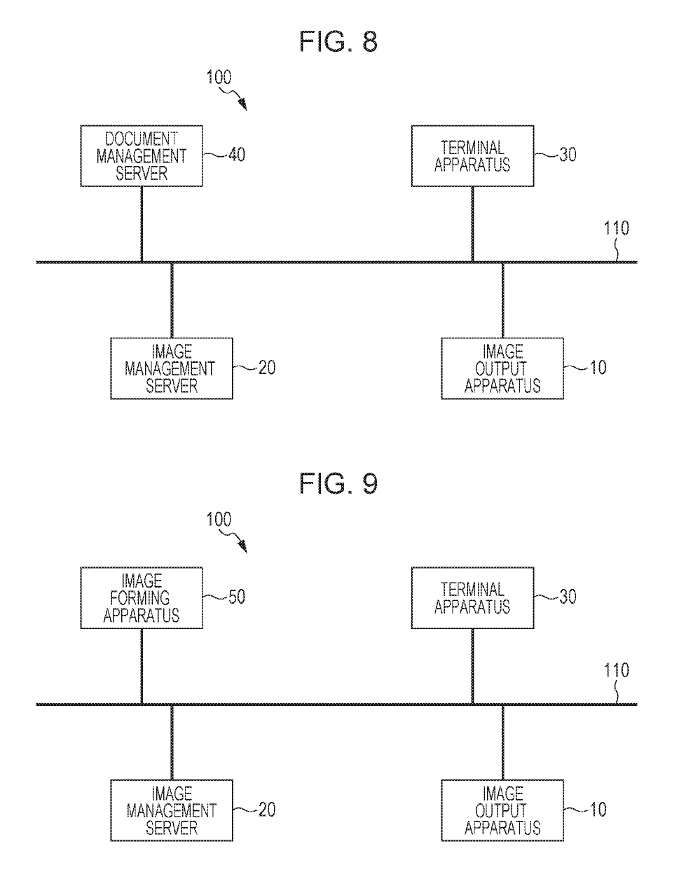

FIG. 9 is a diagram illustrating another example of a configuration of the image management system 100 according to an exemplary embodiment. In the configuration example illustrated in FIG. 9, as an external apparatus that issues a request to the image management server 20 for an image file, an image forming apparatus 50 that is connected to the network 110 is provided. The image forming apparatus 50 acquires a document file and an image file from a server on the network 110 and performs formation and output of an image, by an operation on an operation panel or a remote operation via the network. With this configuration, when the image forming apparatus 50 issues a request to the image management server 20 for an image, the request specifying a document, the image management server 20 transmits the image file of the specified document and, if an image file associated with the specified document exists, the image file associated with the specified document to the image forming apparatus 50. The image forming apparatus 50 forms and outputs an image on a recording material such as paper, based on the image file acquired from the image management server 20. Furthermore, this system configuration may further include the document management server 40, as illustrated in FIG. 8. With this configuration, for a specified document, the image forming apparatus 50 performs formation and output of an image, based on a document file acquired from the document management server 40. Then, only for an image associated with the specified document, the image forming apparatus 50 performs formation and output of an image, based on an image file acquired from the image management server 20.

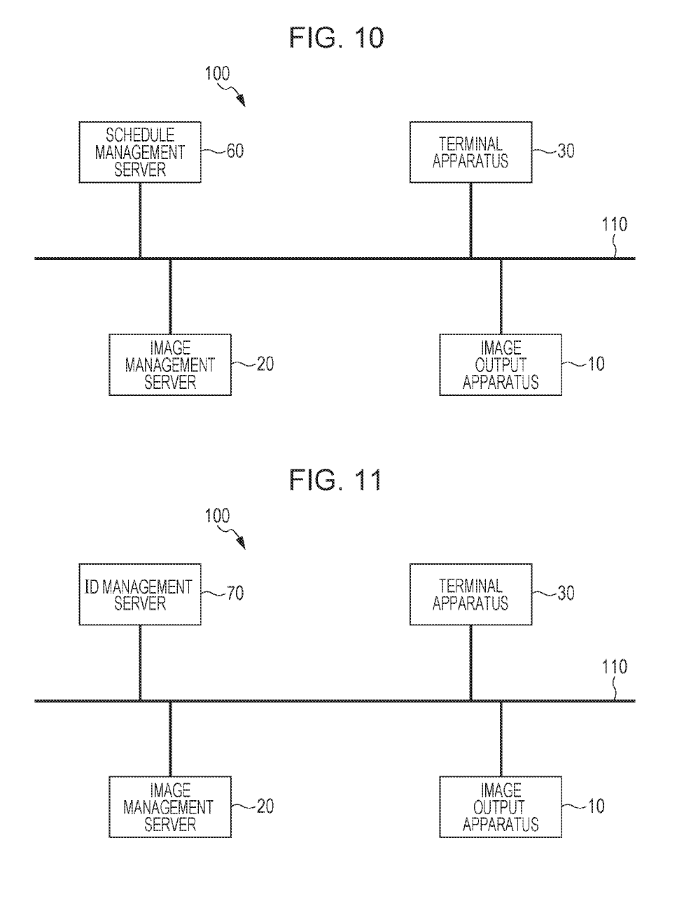

FIG. 10 is a diagram illustrating another example of a configuration of the image management system 100 according to an exemplary embodiment. In the configuration example illustrated in FIG. 10, a schedule management server 60 that manages an event schedule is provided on the network 110. With this configuration, the image management server 20 may acquire identification information of an event from the terminal apparatus 30 or the like, acquire information (for example, date and time, location, participants, etc.) of the event from the schedule management server 60 in accordance with the identification information, and establish a database to be managed by the data management unit 24.

FIG. 11 is a diagram illustrating another example of a configuration of the image management system 100 according to an exemplary embodiment. In the configuration example illustrated in FIG. 11, an ID management server 70 is provided on the network 110. On assuming that the image management system 100 according to this exemplary embodiment is used by a specific organization (a company, a committee, etc.), the image management system 100 cooperates with an ID management system in which information of members of the organization (employees, members, etc.) is managed by the ID management server 70. With this configuration, for example, an authenticating unit using the ID management server 70 is provided in the image output apparatus 10, so that authentication for an operator of the image output apparatus 10 at an event may be performed. Accordingly, a participant of the event who operates the image output apparatus 10 to display an image (that is, a provider of a document as a handout or a document different from the handout) may be identified.

A system configuration in an exemplary embodiment is not limited to any of the system configuration examples explained above with reference to FIG. 1 and FIGS. 8 to 11. An image management system according to an exemplary embodiment may be used in cooperation with various servers and information processing systems.

### <Modifications>

In the foregoing exemplary embodiments, an event such as a conference in which an image file is acquired is registered in advance in the image management server 20. However, events may be cut and divided according to the use state or the like of the image output apparatus 10. For example, in the case where the power of the image output apparatus 10 is kept in an ON state for a while, then turned off, and a predetermined time or more has passed, the period from a time at which the power is turned on until the predetermined time has passed may be defined as a time during which the event has taken place. Furthermore, in the case where a state in which no image file is transmitted from the image output apparatus 10, instead of an OFF state, has been kept for a predetermined time or more, the time when the predetermined time passed since transmission of the last image file may be defined as the time at which the event ended. Furthermore, by using information of the ID management system explained above with reference to FIG. 11 or a human sensor, people who stay at a location where the image output apparatus 10 is used may be identified as participants of an event, and the time when all the participants left the location may be defined as the time at which the event ended.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image management system comprising:
an image output apparatus that displays and outputs an image; and
an image management server that manages the image output from the image output apparatus,
wherein the image output apparatus captures, as image files, an image that is based on a specific data file and an image that is not based on the specific data file, in accordance with a predetermined capture condition, and transmits the image files to the image management server, and
wherein the image management server includes
a management unit that holds the image files received from the image output apparatus, and manages the image that is not based on the specific data file in association with the specific data file, and
a communication controller that transmits, when receiving a request for an image, the request specifying the specific data file, the image associated with the specific data file.

2. The image management system according to claim 1, wherein the image output apparatus captures an image file in accordance with the capture condition that an image to be output is changed.

3. The image management system according to claim 1, wherein the image output apparatus captures an image file in accordance with the capture condition that a predetermined time has passed since an image to be output is changed.

4. The image management system according to claim 1,
wherein the communication controller of the image management server transmits, when receiving a request for an image, the request specifying the specific data file, the image associated with the specific data file and the image that is based on the specific data file.

5. The image management system according to claim 2,
wherein the communication controller of the image management server transmits, when receiving a request for an image, the request specifying the specific data file, the image associated with the specific data file and the image that is based on the specific data file.

6. The image management system according to claim 3,
wherein the communication controller of the image management server transmits, when receiving a request for an image, the request specifying the specific data file, the image associated with the specific data file and the image that is based on the specific data file.

7. The image management system according to claim 1, further comprising:
a file management server that manages the specific data file,
wherein when receiving a request for an image, the request specifying the specific data file, the image management server instructs the file management server to transmit the specified specific data file to a request source.

8. The image management system according to claim 2, further comprising:
a file management server that manages the specific data file,
wherein when receiving a request for an image, the request specifying the specific data file, the image management server instructs the file management server to transmit the specified specific data file to a request source.

9. The image management system according to claim 3, further comprising:
a file management server that manages the specific data file,
wherein when receiving a request for an image, the request specifying the specific data file, the image management server instructs the file management server to transmit the specified specific data file to a request source.

10. The image management system according to claim 7,
wherein when receiving a request for the specific data file, the file management server instructs the image management server to transmit the image associated with the specific data file to the request source, and
wherein the communication controller of the image management server transmits the image associated with the specific data file to the request source for the specific data file, in accordance with the instruction from the file management server.

11. The image management system according to claim 8,
wherein when receiving a request for the specific data file, the file management server instructs the image management server to transmit the image associated with the specific data file to the request source, and
wherein the communication controller of the image management server transmits the image associated with the specific data file to the request source for the specific data file, in accordance with the instruction from the file management server.

12. The image management system according to claim 9,
wherein when receiving a request for the specific data file, the file management server instructs the image management server to transmit the image associated with the specific data file to the request source, and
wherein the communication controller of the image management server transmits the image associated with the specific data file to the request source for the specific data file, in accordance with the instruction from the file management server.

13. An image management server comprising:
an image file acquisition unit that acquires image files of an image that is based on a specific data file displayed and output by an image output apparatus and an image that is not based on the specific data file;
a management unit that holds the image files in a case where the images of the image files are displayed, and manages the image that is not based on the specific data file in association with the specific data file; and
a communication controller that transmits, when receiving a request for an image, the request specifying the specific data file, the image associated with the specific data file.

14. A non-transitory computer readable medium storing a program causing a computer to execute a process for image management, the process comprising:
acquiring image files of an image that is based on a specific data file displayed and output by an image output apparatus and an image that is not based on the specific data file;
causing the image files to be stored in a memory in a case where the images of the image files are displayed, and managing the image that is not based on the specific data file in association with the specific data file; and
transmitting, when receiving a request for an image, the request specifying the specific data file, the image associated with the specific data file.
